(19) United States
(12) Patent Application Publication
(10) Pub. No.: US 2016/0344276 A1
(43) Pub. Date: Nov. 24, 2016

(54) Apparatus to replicate cloud conditions to form electrical charges in a magnetic field

(71) Applicant: Joseph B. Priestley, JR., Ponte Vedra Beach, FL (US)

(72) Inventor: Joseph B. Priestley, JR., Ponte Vedra Beach, FL (US)

(21) Appl. No.: 14/545,546

(22) Filed: May 19, 2015

(51) Int. Cl. H02K 99/00

(52) U.S. Cl. CPC H02K 57/003

(57) ABSTRACT

Apparatus to produce electrical charges in a magnetic field includes a housing, a water source, a rotating hollow cylindrical member, and low pressure generation apparatus. The cylindrical member and low pressure generation apparatus form a helical column of ambient air to draw water particles from the water source and rotate the water particles in a generally horizontal plane in the earth's magnetic field.

This invention relates to apparatus to generate electricity.

More particularly, the invention relates to apparatus that utilizes electrically conductive water to generate electricity.

In a further respect, the invention relates to apparatus that mimics selected cloud conditions to produce electricity.

In still another respect, the invention relates to the formation of a controlled water spout in which the speed of rotation of the water spout can be varied and controlled.

Those of ordinary skill in the art have for many years endeavored to provide new and improved apparatus to generate electricity.

Therefore it would be highly desirable to produce an improved apparatus and method to produce electricity.

Accordingly, it is a principle object of the invention to produce an improved apparatus and method to produce electricity.

These, and other and further objectives will be apparent to those of skill in the art from the following detailed description thereof, taken in conjunction with the drawing, in which:

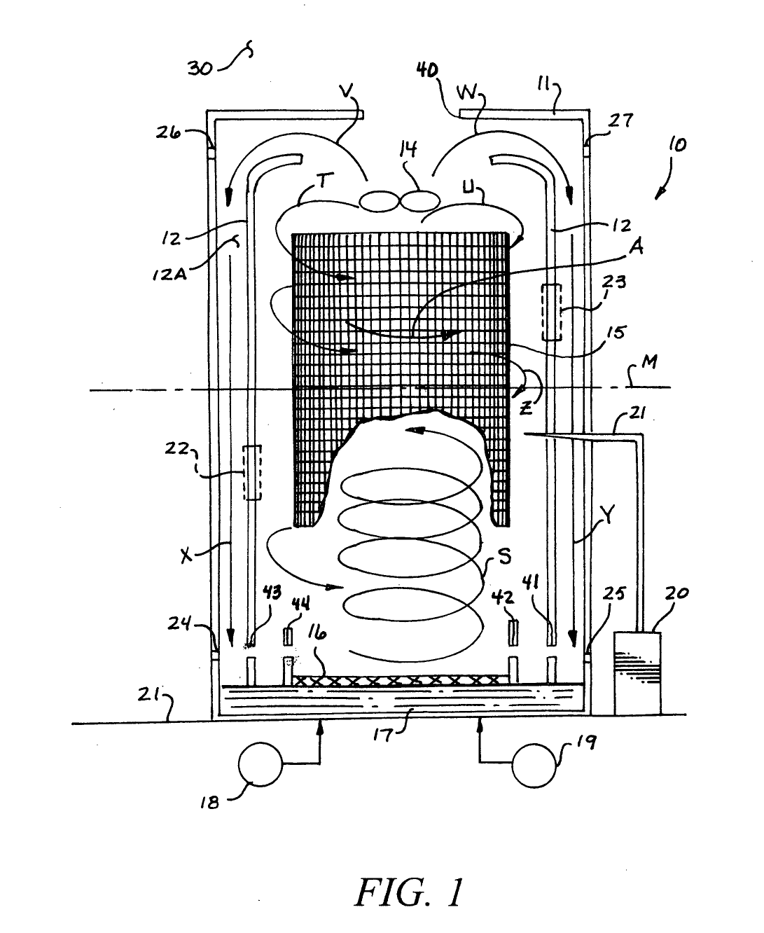

FIG. 1 is a partial section view illustrating apparatus constructed in accordance with the invention; and,

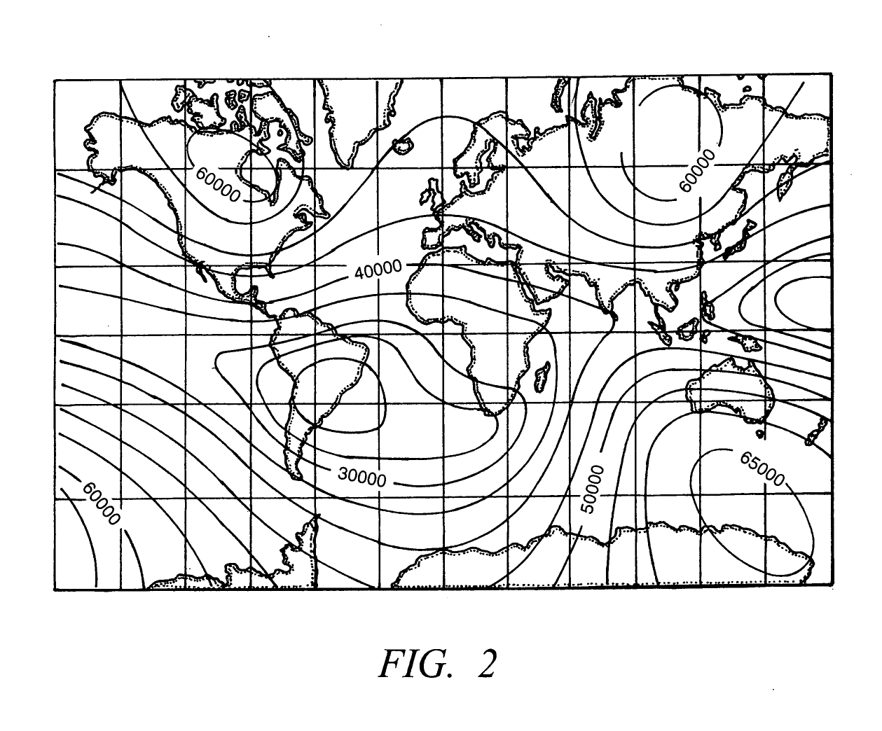

FIG. 2 is a diagram illustrating the strength of earth's magnetic field at varying locations.

Briefly, in accordance with the invention, provided is improved apparatus to produce electrical charges in a magnetic field. The apparatus comprises a housing including at least one vent to the ambient atmosphere, the atmosphere comprising ambient air including particulate nuclei upon which water can gather to form water droplets; a water source comprising electrically conductive water; a rotating hollow cylindrical member in the housing above the water source; a screen adjacent the water source and intermediate the hollow cylindrical member and the water source to draw water from the water source by capillary action; and, low pressure generation apparatus in the housing above the water source and operatively associated with the cylindrical member. The low pressure generation apparatus and said cylindrical member generating an updraft comprising a rising helical column of ambient air which extends above the water source, and draws water from the water source to gather on the particulate nuclei to form water droplets to be drawn in the updraft along a path of travel generally normal to the earth's magnetic field to form a controlled water spout, to move to a location to rotate in a generally horizontally oriented plane, and to generate electrical charge. The cylindrical member produces a rotational component to initiate the formation of the helical column of ambient air. The low pressure generation apparatus generates a low pressure area to initiate the formation of the helical column of ambient air and control the speed of rotation of the helical column of ambient air. The apparatus also includes ducting operatively associated with and extending intermediate the housing and the hollow cylindrical member to receive at least a portion of the rising helical column of air and the water bearing particulate nuclei and redirect the air and nuclei in a downdraft back toward the water source.

Turning now to the drawing which illustrates the presently preferred embodiment by way of illustration and not limitation, FIG. 1 illustrates apparatus to replicate cloud conditions to form electrical charges in a magnetic field. The apparatus is generally indicated by reference character 10.

The apparatus 10 includes a housing 11 including at least one vent 24 to 27, 40 to 44 to the ambient atmosphere 30. Ambient air normally is drawn into housing 11 through vents 24, 25, 41 to 44. Air, along with any moisture contained in the air, exits housing 11 through vents 26, 27, 40. Ambient atmosphere 30 comprises in part ambient air. The ambient air includes particulate nuclei upon which water can condense or otherwise gather to form water droplets. Even the air, however, inside a normal building structure includes particulate nuclei unless a very efficient filtering system is installed. Such efficient filtering systems normally are only found in certain scientific laboratories. Filtering systems found in most residential homes and commercial building may succeed in removing some particulate nuclei from air in those building structures, but removing all such nuclei is a difficult proposition and extremely unlikely. Consequently, air utilized in the apparatus of the invention includes a concentration of particulate nuclei.

Apparatus 10 also includes a reservoir or other water source 17 comprising electrically conductive water; includes a rotating hollow cylindrical screen member 15 in the housing above the water source 17; includes a screen or mesh 16 adjacent the water source 17 and intermediate the hollow cylindrical member 15 and the water source 17 to draw water from the water source by capillary action; and, includes a rotating fan 14 or other low pressure generating apparatus in the housing above the water source and operatively associated with the cylindrical screen member 15. Openings in screen or mesh 16 are sized to produce a desired size of water particle that can escape screen 16 and be drawn into updraft or vortex S in the manner described below. Screens 16 having different sized openings can be provided. For example, one screen 16 might have openings with a maximum width of one-sixteenth of an inch. Another screen 16 might have openings with a maximum width of one-thirty-second of an inch. Still another screen 16 might have a combination of different sized openings. The number of openings per square inch in a screen 16 can also be varied to meter the rate at which updraft S removes water from reservoir 17. Or only a portion of the surface area of screen 16 which is exposed to updraft S may be perforated so that the volume of water drawn upwardly through screen 16 per minute by updraft S can be varied depending on the size of the cross-sectional area of the portion of screen 16 which is perforated.

Member 15 rotates in the direction of arrow A, but the direction of rotation can, as would be appreciated by those of skill in the art, be reversed. The fan 14 and the cylindrical member 15 together function to generate an updraft S comprising a rising helical column of ambient air extending above the water source 17. Updraft or vortex S draws water and/or water vapor from the water source 17 and/or screen 16. The water or water vapor can condense or gather on particulate nuclei in the updraft S, or, can simply be drawn into updraft S free of particulate nuclei.

Member 15 is important in the initial formation of the rotating helical column of ambient air, or vortex, extending above the water source 17, as is fan 14 (or some other low pressure generating apparatus). However, after a water spout is formed comprising the rotating column of ambient air and water droplets in the rotating column of air are formed, fan 14 is, importantly, utilized to control the speed of rotation of the water spout. After the water spout is formed the rotation of member 15 can, if desired, be halted, but the generation of low pressure must continue. Increasing the speed of rotation of fan 14 to further lower the pressure in the water spout functions to increase the speed of rotation of the water spout. In contrast, decreasing the speed of rotation of fan 14 to increase the pressure in the water spout functions to decrease the speed of rotation of the water spout. Being able to vary the magnitude of the low pressure created in the water spout is critical in the practice of the invention, in particular because (1) the speed of rotation of the water spout can be varied to produce a particular desired quantity of electricity per unit time, and (2) the speed of rotation of the water spout can be readily decreased if for some reason the apparatus of the invention is producing a greater quantity of electrical energy than is desired, especially if the quantity of electrical energy produced is dangerous or unsafe. Consequently, fan 14 ordinarily includes a variable speed motor or other apparatus for operating fan 14 to vary the magnitude of the pressure in the water spout to control the speed of rotation of the water spout. Vent 40 permits outflow produced by fan 14 to exit into the ambient atmosphere.

Updaft or vortex S travels along an upward path of travel generally normal, or at some other selected angle, to the earth's magnetic field M. FIG. 2 illustrates the strength of the earth's magnetic field at various locations on the surface of the globe. Electrically conductive water in updraft S interacts with magnetic field M to generate electrical charge. The orientation of the earth's magnetic field lines varies depending on location.

Apparatus 10 also includes hollow cylindrically shaped duct wall 12 operatively associated with and extending intermediate member 15 and housing 11. Wall 12 is operatively associated with member 15 and housing 11 and functions to receive at least a portion of updraft S to redirect air, particulate nuclei and water or water vapor in a downdraft back toward the water source 17. The downdraft can travel intermediate the housing 11 and duct wall 12 in the manner indicated by arrows V, W, X, and Y; or, can travel inside duct wall 12 and around member 15 in a downward path in the manner indicated by arrows U, T, A, and Z. The downward path can be helical in a direction comparable to the direction of rotation of member 15; or, can be more of a direct downward path of travel comparable to that indicated by arrows X and Y in the space 12A intermediate duct wall 12 and housing 11. Producing a helical downdraft which extends between duct wall 12 and member 15 is presently preferred because air and water particles flowing adjacent member 15 includes particles which collide with member 15 and produce electrical charges. The production of updrafts and downdrafts which carry electrically conductive water through the earth's magnetic field is believed critical in the practice of one embodiment of the invention, especially when an updraft moves through the earth's magnetic field along a helical path of travel. Such a helical updraft produces particle movement having vertical force vector components, having horizontal force vector components acting in opposing directions (due to the helical path of travel of particles), and generating centrifugal forces on particles. These multiple forces all interact with the earth's magnetic field or with other magnetic fields produced in apparatus 10 in accordance with the invention. These multiple force also promote particle-to-particle contact in updraft S and promote the contact of particles in updraft S (or in the downdraft indicated by arrows T and Z) with member 15.

In accordance with another embodiment of the invention, the size and/or speed of rotation of the water spout formed with fan 14 and member 15 is varied to adjust the size of water particles which are drawn into or suspended in the water spout.

In accordance with a further embodiment of the invention, the size and/or speed of rotation of the water spout formed with fan 14 and member 15 is varied to adjust the size of water particles in the water spout such that at least some of the water particles in the water spout rotate in a generally horizontally oriented plane for a selected period of time.

In one embodiment of the invention, screen member 15 is fabricated from an electrically conductive material.

Electrically conductive probe 12 collects electrical charge generated in housing 11 and transmits the charge to a battery bank 20 or other source for storing or using the electricity.

Pump 19 replenishes reservoir 17 as necessary.

Pump 18 directs liquid, solid particulate such a copper powder, or other additives into the water in source 17 in order to increase the electrical conductivity of the water. Distilled water is not preferred in the practice of the invention because distilled water is electrically conductive to only a very small degree.

The rotational speeds of fan 14 and member 15 can be varied as desired to alter the quantity of electric charges produced by apparatus 10. In FIG. 1, member 15 and fan 14 each rotate about a horizontal axis. If desired the axis of rotation for member 15 and fan 14 can be horizontally oriented or canted at some angle intermediate the horizontal and the vertical.

The size of apparatus 10 can vary as desired.

Complex rules of electromagnetism govern the forces and torques that magnets exert on each other. Each magnet has a force of attraction field produced by microscopic currents of electrically charged electrons and by the innate magnetism of particles like electrons that make up a material. The magnetic dipole-dipole interaction is the most elementary force between magnets.

Accordingly, if desired, the magnetic field of the earth can be supplemented and affected by incorporating in the apparatus of FIG. 1 magnets 22, 23 or other apparatus which generates a supplemental magnetic field which extends into the housing 11, and can interact with the earth's magnetic field or other magnetic fields. The size, strength, and shape of a supplemental magnetic field can be varied as desired.

The orientation of the supplemental magnetic field can also be varied as desired. For example, if the earth's magnetic field lines are generally perpendicular to the axis of rotation of member 15 in FIG. 1 (which could be the case for locations at or near the earth's equator), a supplemental magnetic field can be used which produces magnetic field lines that are perpendicular (or parallel or at an angle other than ninety degrees) to the earth's magnetic field lines.

Producing a supplemental magnetic field with field lines that are parallel to and strengthen the earth's magnetic field lines may be desirable, as may be producing a supplemental magnetic field with field lines that are at an angle to the earth's magnetic field lines.

Further, if a magnet or other field generating apparatus is used which reverses the position of the “poles”, that may produce a desirable effect. For example, if a person is standing at the Statue of Liberty, the north magnetic pole of the earth is located to the north and the south magnetic pole of the earth is located to the south. If a bar magnet is held or oriented such that the north end of the bar magnet is closer to the earth's south pole than the earth's north pole and the south end of the bar magnet is closer to the earth's north pole than the earth's south pole, then the magnetic field lines of the bar magnetic theoretically may be “traveling” in a direction opposite the earth's magnetic field lines. Such opposing magnetic field lines may produce a desirable effect in the apparatus of the invention.

And, the intersection of magnetic field lines that are canted with respect to one another may produce a desirable effect such as, by way of example and not limitation, generating a greater quantity of electricity as compared to the electricity generated by magnetic field lines which each are oriented in a common direction. Magnetic field lines which are oriented in a common direction may or may not, as noted above, be “traveling” in a common direction.

Having described my invention in such terms as to make it structure and use evident to those of skill in the art, I claim:

1. Apparatus to produce electrical charges in a magnetic field, comprising
(a) a housing including at least one vent to the ambient atmosphere, the atmosphere comprising ambient air including particulate nuclei upon which water can gather to form water droplets;
(b) a water source comprising electrically conductive water;
(c) a rotating hollow cylindrical member in said housing above said water source;
(d) a screen adjacent said water source and intermediate said hollow cylindrical member and said water source to draw water from said water source by capillary action;
(e) low pressure generation apparatus in said housing above said water source and operatively associated with said cylindrical member, said low pressure generation apparatus and said cylindrical member generating an updraft comprising a rising helical column of ambient air which extends above said water source, and draws water from said water source to gather on the particulate nuclei to form water droplets to
(i) be drawn in the updraft along a path of travel generally normal to the earth's magnetic field to form a water spout,
(ii) move to a location to rotate in a generally horizontally oriented plane, and
(iii) to generate electrical charge,
said cylindrical member producing a rotational component to initiate the formation of said helical column of ambient air, and
said low pressure generation apparatus generating a low pressure area to initiate the formation of said helical column of ambient air and control the speed of rotation of said helical column of ambient air after said helical column of ambient air is formed; and
(f) ducting operatively associated with and extending intermediate said housing and said hollow cylindrical member to receive at least a portion of the rising helical column of air and the water bearing particulate nuclei and redirect the air and nuclei in a downdraft back toward said water source.
